(19) United States
(12) Patent Application Publication
(10) Pub. No.: US 2018/0024542 A1
(43) Pub. Date: Jan. 25, 2018

(54) SYSTEM AND METHOD TO DETECT SMART DEVICE CONFIGURATION CHANGES AGAINST A REFERENCE IN PROCESS CONTROL SYSTEMS

(71) Applicant: Honeywell International Inc., Morris Plains, NJ (US)

(72) Inventors: Susanta Kumar Naik, Hyderabad (IN); Kesavanand Chavali, Hyderabad (IN); Peter Overgaauw, Blaricum (NL)

(21) Appl. No.: 15/217,882

(22) Filed: Jul. 22, 2016

(51) Int. Cl. G05B 19/418; G05B 11/01

(52) U.S. Cl. CPC G05B 19/41865; G05B 19/4184; G05B 11/01; G05B 2219/36381

(57) ABSTRACT

A method is provided for comparing a master gold record with a live device in an industrial automation system. The method includes receiving a master golden record for a device of a plurality of devices in the industrial automation system. The master golden record includes one or more parameter values for the device for a mode of the industrial automation system. The method also includes identifying an active mode for the industrial automation system. The method also includes responsive to a triggering of a comparison, comparing current parameter values of the device with the one or more parameter values of the master golden record for the active mode. The method also includes generating a report comprising differences between the one or more parameters values of the master golden record and the current parameter values of the device.

### TECHNICAL FIELD

This disclosure is generally directed to field devices in a plant. More specifically, this disclosure is directed to an apparatus and method to detect smart device configuration changes against a reference in process control systems.

### BACKGROUND

Industrial control systems (ICS) can adhere to safety guidelines set by the International Electrotechnical Commission (IEC). An IEC Final Draft International Standard (FDIS) 61511-1 guidelines have set that smart device configurations should not be changed post commissioning. IEC 61511 categorizes smart instruments as type B devices and fixed program language (FPL) devices. If an accident occurs and these guidelines are not followed, it will be difficult to justify why a company did not comply with the guidelines. Periodically, a report is generated for safety audit purposes to show that the smart device configuration have not changed since commissioning. Customers are concerned that any change in smart device configuration could severely impact their process (continuous/batch). Producing a report for a single smart device could take around an hour. Factories can have more many smart devices, ultimately consuming more manual effort and increasing costs. Customers might miss producing the periodic reports because of many manual dependencies. A maintenance engineer must be well trained to generate the reports, as it involves selecting a right reference and ignoring non-configuration parameters. As the method is human dependent, there can be human errors.

### SUMMARY

This disclosure provides an apparatus and method to detect smart device configuration changes against a reference in process control systems.

In a first example, a method is provided for managing a master gold record in an industrial automation system. The method includes receiving a master golden record for a device of a plurality of devices in the industrial automation system. The master golden record includes one or more parameter values for the device for a mode of the industrial automation system. The method also includes identifying an active mode for the industrial automation system. The method also includes responsive to a triggering of a comparison, comparing current parameter values of the device with the one or more parameter values of the master golden record for the active mode. The method also includes generating a report comprising differences between the one or more parameters values of the master golden record and the current parameter values of the device.

In a second example, an apparatus includes a memory configured to store a master golden record. The apparatus also includes a processing device coupled to the memory. The processing device is configured to receive the master golden record for a device of a plurality of devices in a industrial automation system. The master golden record includes one or more parameter values for the device for a mode of the industrial automation system. The processing device is also configured to identify an active mode for the industrial automation system. The processing device is also configured to responsive to a triggering of a comparison, compare current parameter values of the device with the one or more parameter values of the master golden record for the active mode. The processing device is also configured to generate a report comprising differences between the one or more parameters values of the master golden record and the current parameter values of the device.

In a third example, a non-transitory computer readable medium includes a computer program. The computer program comprises computer readable program code for receiving a master golden record for a device of a plurality of devices in a industrial automation system. The master golden record includes one or more parameter values for the device for a mode of the industrial automation system. The computer readable program code is also for identifying an active mode for the industrial automation system. The computer readable program code is also for responsive to a triggering of a comparison, comparing current parameter values of the device with the one or more parameter values of the master golden record for the active mode. The computer readable program code is also for generating a report comprising differences between the one or more parameters values of the master golden record and the current parameter values of the device.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example industrial process control and automation system and related details according to this disclosure;

FIG. 2 illustrates an example device for managing recordation of changes in a smart device according to this disclosure;

FIG. 3 illustrates an example block diagram of a configuration management system according to this disclosure; and

FIG. 4 illustrates an example master golden record management process according to this disclosure.

### DETAILED DESCRIPTION

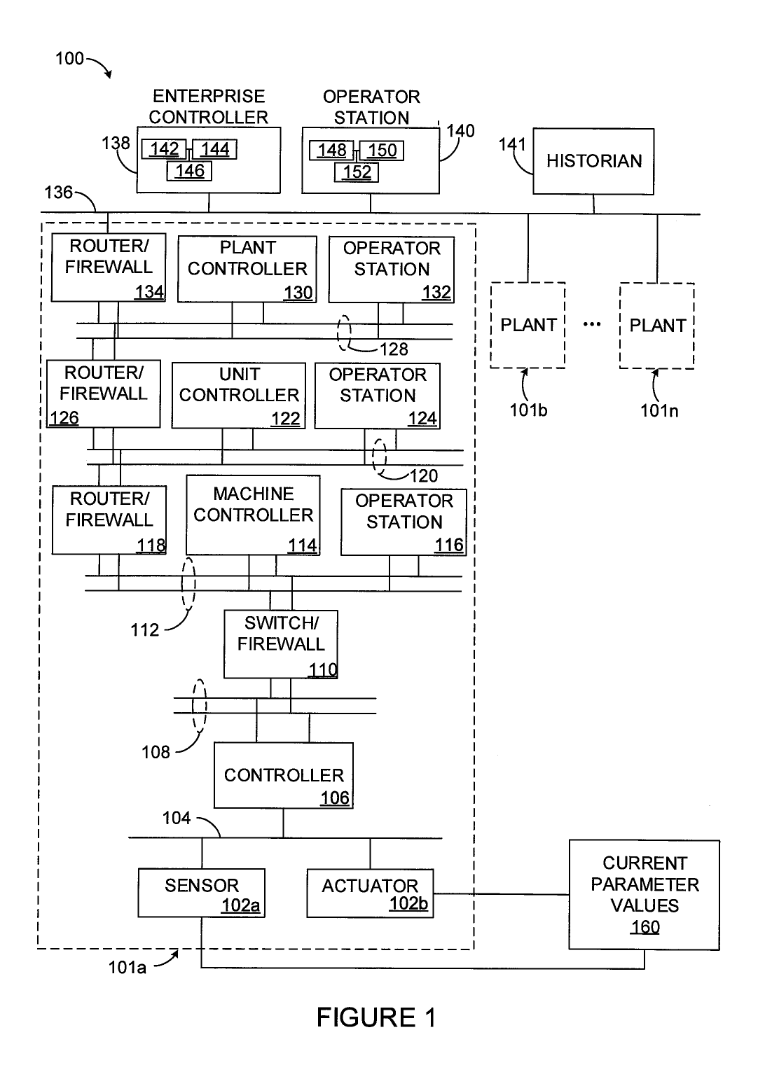

FIGS. 1 through 4, discussed below, and the various examples used to describe the principles of the present invention in this patent document are by way of illustration only and should not be construed in any way to limit the scope of the invention. Those skilled in the art will understand that the principles of the present invention may be implemented in any suitable manner and in any type of suitably arranged device or system.

FIG. 1 illustrates an example industrial process control and automation system 100 and related details according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller, or other type of controller implementing model predictive control (MPC) or other advanced predictive control (APC). As a particular example, each controller 106 could represent a computing device running a real-time operating system.

In one or more example embodiments of this disclosure, sensors 102a and actuators 102b can be smart devices. These smart devices can include different parameter values 160. Parameter values 160 can be settings and configurations of a smart device to perform specific functions in an active mode of the system 100. For example, Lower Range Value (LRV) and Upper Range Value (URV) can be configuration parameters while Primary value (PV) can be a non-configuration parameter. Each smart device can have different values for different modes. The different modes can be set based on product, version of the product being manufactured, or a service being executed.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (IVIES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

Although FIG. 1 illustrates one example of an industrial process control and automation system 100, various changes may be made to FIG. 1. For example, a control and automation system could include any number of sensors, actuators, controllers, operator stations, networks, servers, communication devices, and other components. In addition, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which information related to an industrial process control and automation system can be transmitted to a remote server. This functionality can be used in any other suitable system.

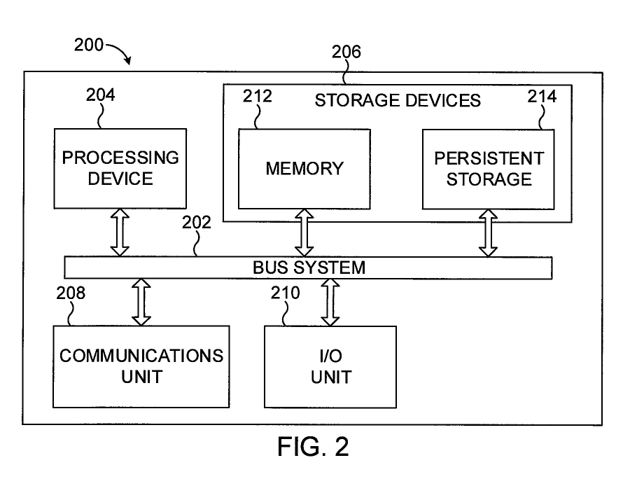

FIG. 2 illustrates an example device 200 for managing recordation of changes in a smart device according to this disclosure. The device 200 could represent, for example, the field device 102, enterprise controller 138, operator station 140, or a local or remote server in the system 100 of FIG. 1. However, the device 200 could be used in any other suitable system.

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a ready only memory, hard drive, Flash memory, or optical disc.

The communications unit 208 supports communications with other systems or devices. For example, the communications unit 208 could include a network interface that facilitates communications over at least one Ethernet, HART, FOUNDATION FIELDBUS, cellular, Wi-Fi, universal asynchronous receiver/transmitter (UART), serial peripheral interface (SPI) or other network. The communications unit 208 could also include a wireless transceiver facilitating communications over at least one wireless network. The communications unit 208 may support communications through any suitable physical or wireless communication link(s). The communications unit 208 may support communications through multiple different interfaces, or may be representative of multiple communication units with the ability to communication through multiple interfaces.

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

The device 200 could execute instructions used to perform any of the functions associated with the components of FIG. 1. For example, the device 200 could execute instructions that retrieve and upload information to and from a transmitter or field device. The device 200 could also store user databases.

Although FIG. 2 illustrates one example of a device 200, various changes may be made to FIG. 2. For example, components could be added, omitted, combined, further subdivided, or placed in any other suitable configuration according to particular needs. Also, computing devices can come in a wide variety of configurations, and FIG. 2 does not limit this disclosure to any particular configuration of computing device.

One or more embodiments of this disclosure recognize and take into account that currently an operator chooses an appropriate master golden record (MGR) based on a current plant mode for a smart device. The operator can compare a current online configuration of the smart device with the above selected MGR either manually or by using any compare configuration tools if any provided by existing asset management systems. The operator is able to use personal best knowledge or consult an appropriate guide to determine if any configuration has changed, generate a report manually, and archive the report. The operator may repeat the process for all other smart devices for which reporting is required. Generating a report for a single smart device can take significant amount of time. For a plant where the number of smart devices can be thousands, the approximate manual effort for generating reports for all smart devices would consume many more thousands of man-hours.

One or more embodiments of this disclosure provides an industrial automation system and an automated procedure to periodically compare the current online configuration parameter values of one or more smart devices with its respective MGR in the current running plant modes. The solution does so in defined schedule, notifies the status of execution to the user and generates report. Report will be archived for future retrieval. The solutions also audit trails all the user actions for future audits.

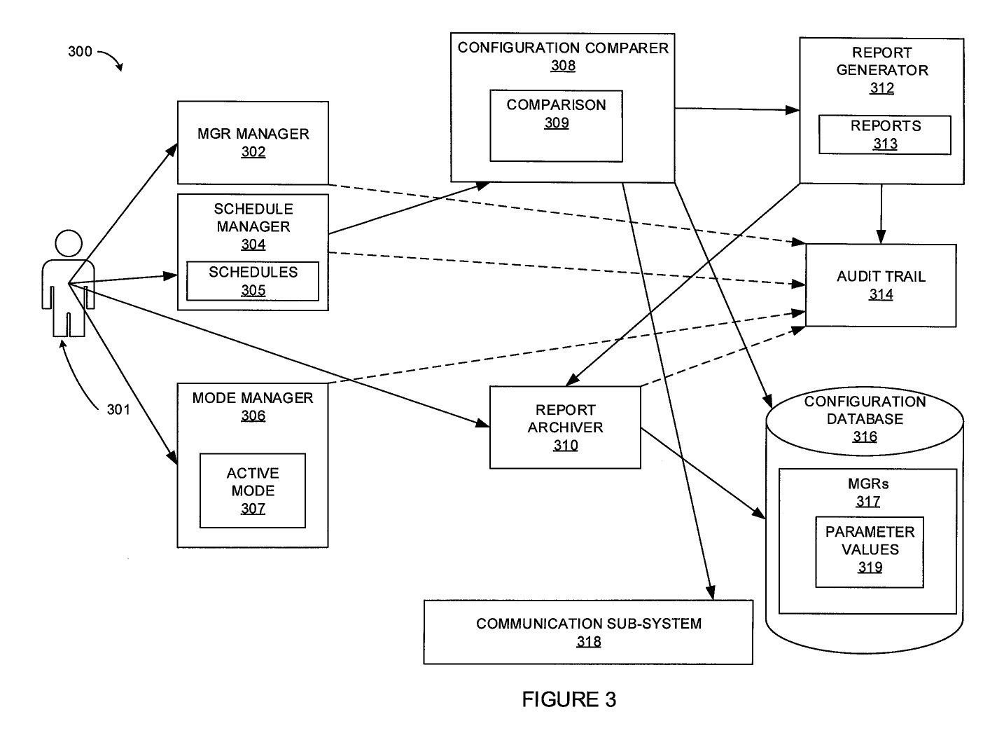

FIG. 3 illustrates an example block diagram of a configuration management system 300 according to this disclosure. For ease of explanation, the system 300 is described as being supported by the industrial process control and automation system 100 of FIG. 1. However, the system 300 could be supported by any other suitable system. The system 300 can be implemented in a device, such as device 200 as shown in FIG. 2.

In FIG. 3, system 300 includes master golden record (MGR) manager 302, schedule manager 304, mode manager 306, configuration comparer 308, report archiver 310, report generator 312, audit trail 314, configuration database 316, and communication sub-system 318. The system 300 can communicate with different smart devices, such as components on FIG. 1, through the communication sub-system 318. One or more of the components 302-318 used herein can be implemented as part of processing circuitry, instructions on a non-transitory computer readable medium, as a processor, and the like.

In one or more embodiments herein, a smart device can be a field device used in a process control system supporting protocols such as HART, Wireless HART, Foundation Fieldbus, Modbus, IEC 61850, EthernetIP, ISA100, Profibus DP, PA, Profinet, etc. In different embodiments of this disclosure, the smart devices can represent, or be represented by, any of the components 102-134 as shown in FIG. 1. As discussed herein, one or more of the embodiments of this disclosure can be used in any electrical monitoring and control system as well as any process control system. Additionally, the embodiments herein can be in non-safety as well as safety devices.

In an embodiment of this disclosure, the MGR manager 302 is configured to allow a user 301 to create, retrieve, update, and delete the MGR for one or more smart devices. The MGR can be the project engineering configuration parameter with values of any smart device for a given mode. Other terms used for MGR are reference record, golden record, or golden reference record etc. Any history or offline record can be marked as a MGR. the user 301 may define multiple groups of devices that can be verified against a golden record. For batch comparisons, a specific group of devices can be selected each time. In different embodiments, a golden record can be created from a live device.

In different embodiments, a golden record can be a single, well-defined version of all the data entities in an organizational ecosystem. In this context, a golden record is sometimes called the “single version of the truth,” where “truth” is understood to mean the reference to which data users can turn when they want to ensure that they have the correct version of a piece of information. The golden record encompasses all the data in every system of record (SOR) within a particular organization. A SOR is an information storage and retrieval system (ISRS) that serves as the authoritative source for a particular data element in an industrial automation system containing multiple sources of the same element. To ensure data integrity, a single SOR must always exist for each and every data element.

In one or more embodiments herein, a history record is the snapshot of the parameter values of any smart device taken at a given point of interest. The history record can be the same as taking a backup of the parameter values from an online smart device. For example, the backup can be a snapshot taken after commissioning of the smart device, after factory acceptance test, and the like. Other terms used for history record are device snapshot, and the like. The user can optionally select all configuration parameters or few. In another embodiment, the user or system can mark an existing history record as the MGR. In yet another embodiment, the user or system can mark an existing offline record as the MGR. In one or more embodiments herein, an offline record can be the configuration parameters stored in configuration database 316 that is prepopulated either manually or from a connected smart device. The MGR manager 302 can provide an option to the user to view, update, and delete any MGR. The MGR manager 302 can also map any MGR to a mode.

In one or more embodiments of this disclosure, the MGR is set at a time of commissioning. In different embodiments of this disclosure, the MGR can be set after commissioning. In some example embodiments, after setting, the MGR can be modified, such as by use of a proper management of change procedure.

The schedule manager 304 is configured to provide an option to the user 301 to schedule a one time or periodic (daily, weekly, monthly, etc.) configuration comparison mechanism for one or more smart devices. The schedule manager 304 can also allow the user 301 to retrieve, update and delete schedules 305.

The MGR can be compared to the live online configuration parameter values of any smart device by executing the comparison now, or by scheduling the comparison. For executing now, the schedule manager 304 provides an option to the user to compare online configuration parameter values of a smart device with a MGR. For scheduling, the schedule manager 304 provides an option to create either a one time or recurring schedule for automatic/semiautomatic comparison of online configuration parameter values of a smart device with the MGR.

For an automatic schedule, the schedule manager 304 compares online configuration parameter values of a smart device with the MGR automatically without any user input and archiving the report. For a semiautomatic schedule, the schedule manager 304 compares an online configuration parameter values of a smart device with a MGR post user confirmation via any detectable means such as user interface prompting the user for confirmation or via voice confirmation or via any electronically detectable means like by sending authorization via SMS to a pre defined number, by sending authorization via email to a pre defined E-Mail ID, or the like.

In one or more embodiments, the schedule manager 304 can provide an option to the user to view, update, and delete any schedule. The schedule manager 304 can also provide the user with an option for configuring a reminder for any schedule. The schedule manager 304 can also provide an option to the user for cancelling the occurrence of a schedule or to “snooze” the occurrence to some future time.

The mode manager 306 is configured to provide an option to set the current active modes 307 of the plant. Active mode 307 can be a current mode being used in the plant for an industrial process control and automation system. The mode manager 306 can synchronize the current active modes from the existing distributed control system (DCS), supervisory control and data acquisition (SCADA) system, or programming logic controller (PLC) system automatically or by providing explicit means to update the systems. The mode manager 306 can also allow the 301 to create, retrieve, update and delete modes. In one or more embodiments herein, a mode refers to different production modes of the plant. Difference production modes can be applied to continuous or batch plants, where a startup or high production mode might require different instrumentation settings. Different instrumentation settings can be used in a batch plant where on a particular production line multiple products can be produced. Depending on the product being produced, different product properties may cause different instrument settings to be used.

In different embodiments, multiple golden records can be provided for each device depending on the operational mode of the plant. This type of system can be useful for batch plants or semi-continuous plants that are frequently reconfigured. For example, if there is a soup production line, each device could have one golden record for each device when producing “chicken soup” and another golden record when producing “vegetable soup.” The golden records can be swapped when switching production line items.

In one or more embodiments, the mode manager 306 provides the user with an option to create, retrieve, update and delete modes. The mode manager 306 can sync the modes from DCS, SCADA, or PLC systems automatically or user triggered. The mode manager 306 can set one or more active modes, i.e. the current operating modes of the plant. Setting the modes can involve syncing active modes from DCS, SCADA, or PLC systems.

The MGR manager 302, schedule manager 304, and mode manager 306 can all be accessed by the user 301 to modify an MGR, schedule a comparison 309, or modify a mode of the plant. All of the actions performed with these managers 302, 304, 306 can be recorded by an audit trail subsystem 314.

The configuration comparer 308 is configured to compare the current smart device configuration with a given MGR. The schedule manager 304 can initiate the configuration comparer 308 to begin a comparison 309. The comparison 309 can provide an identification of added, deleted, or changed parameters or configurations of the smart device. To perform the comparison 309, the configuration comparer 308 is configured to access the different smart devices through the communication sub-system 318 and compare the current configurations to the MGRs accessed from the configuration database 316.

In one or more embodiments, the configuration comparer 308 can compare the current smart device configuration parameter values with that of a mapped MGR in the current active mode. The configuration comparer 308 can also identify configuration parameters and comparing only those parameter values while ignoring all other non-configuration parameters. For example, Lower Range Value (LRV) and Upper Range Value (URV) can be configuration parameters while Primary value (PV) can be a non-configuration parameter. The configuration comparer 308 can notify the user about the progress and status of the current execution. The configuration comparer 308 can also allow the user to cancel the current execution. In different embodiments, the configuration comparer 308 can compare the configuration parameter values for multiple smart devices with their respective MGR either sequentially or in parallel. The configuration comparer 308 can be triggered either manually, automatically by the scheduler, or upon authorization from user.

The report generator 312 is configured to generate reports 313 citing differences as reported by the configuration comparer 308. The reports can be presented in different formats. The report can include or exclude different parameters of the smart devices. For example, in one report, all parameters can be included. In other reports, a subset of parameters can be included. The report generator 312 can retrieve the comparison result from execution and prepare a report in the user or system-configured format. The report generator 312 can report the following data (but not limited to): a summary of the overall execution such as how many smart device comparison have failed or passed; a number of smart devices for which a comparison couldn't be performed, the devices are cancelled, or the devices encountered some issues during execution; and the exact configuration parameters that have changed from their respective MGR values. The report generator 312 can provide an option to the user to view, delete any report. The report generator 312 can also provide an option to print or export to file system in any human readable format such as (but not limited to) PDF, HTML, CSV, DOC, XLS, XPS and the like.

The report archiver 310 is configured to archive the report generated by the report generator 312 and provides means for future retrieval. The report archiver 310 can be a database, either local or remote.

The audit trail subsystem 314 is configured to log all user actions with appropriate user, action, and timestamp details. The audit trail subsystem 314 also provides a mechanism to view, modify, and delete these audit trails. The audit trail subsystem 314 audits all user actions such as creating, updating, and deleting of MGRs, modes, or schedules. The audit trail subsystem 314 retrieves audit trail details as required, exports audit trail records to a human readable format, and logs user info, actions performed, time stamp, and any comments. The audit trail subsystem 314 can also provide an option to the user to print audit trail records.

The configuration database 316 can be a database containing the MGRs 317 for each smart device per specific mode. Each of the MGRs can include one or more parameters or values for the one or more parameters for different smart devices. In one or more embodiments herein, a database is a repository for storing and retrieving the required data. The configuration database 316 could be a file system based repository, an RDBMS, a cloud based repository, or the like. Each MGR 317 includes different parameter values 319 for the smart devices. The parameter values can be the settings and configurations for the smart device for each mode of the system.

The communication subsystem 318 is configured to provide communication with the smart devices.

One or more embodiments provides for golden record management by the MGR manager 302. Golden record management involves a creation of a history record from live online smart device configuration parameters (i.e., the parameters of the devices currently in use) and saving those parameters as the MGR. The MGR alternatively can also be created from offline dataset of the smart device.

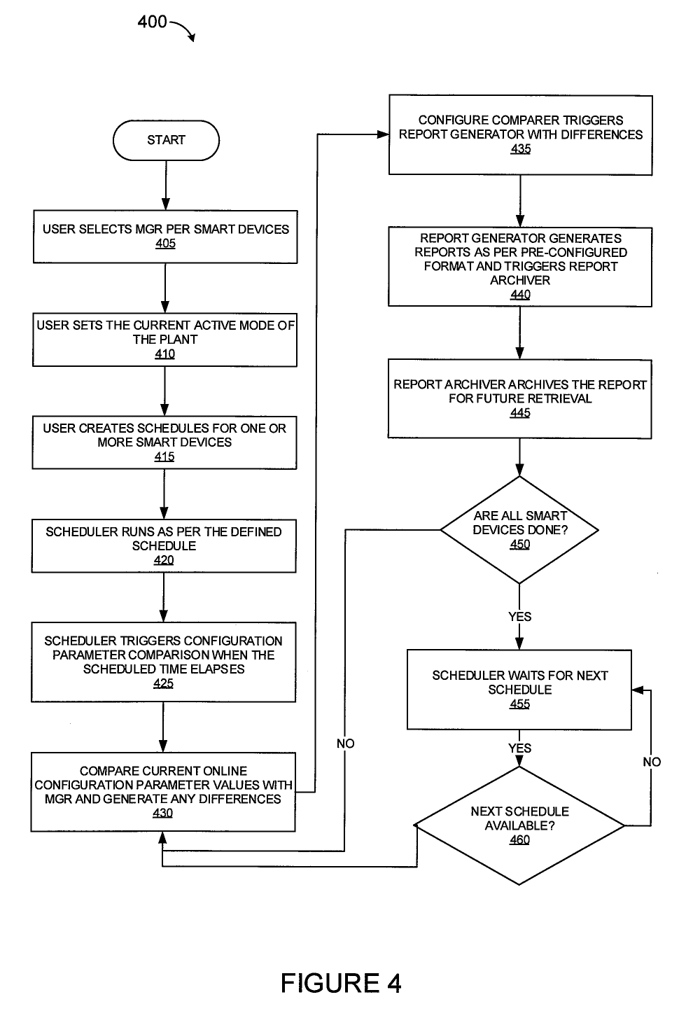

FIG. 4 illustrates an example master golden record management process 400 according to this disclosure. The golden record management process 400 provides for scheduling of a comparison of a MGR with device parameters. Process 400 can be executed within system 300 of FIG. 3 and/or by device 200 of FIG. 2.

At operation 405, a processor receives a user selection of a MGR for each smart device. In different embodiments, the selection can be a batch selection for multiple smart devices. In various embodiments of this disclosure, operation 405 is only performed one time. The same MGR will then be used by the comparer every time a schedule elapses. In further embodiments, the MGR can be chosen on different occasions.

At operation 410, a processor can receive a user setting of a current active mode of a plant. The mode can be based on a product, or a version of a production under production.

At operation 415, a processor receives a new schedule from a user that is created for one or more smart devices. The schedule can set when the comparison is performed. At operation 420, the processor can control a scheduler manager to run a schedule based on the defined schedule.

At operation 425, the processor can control a scheduler manager to trigger a configuration parameter comparison when the scheduled time elapses. While the schedule is running, different scheduled times may elapse and trigger different comparisons. At operation 430, the processor can compare current online configuration parameter values with a MGR and generate any differences of parameters. The current configuration parameter values can be current parameter settings and configurations being used during current production.

At operation 435, the processor can configure a comparer triggers report with differences to use when generating a report. At this operation, the report to be generated can be configured with which differences are to be reported. At operation 440, the processor controls a report generator to generate reports according to the pre-configured format and also trigger a report archiver.

At operation 445, the processor controls a report archiver to archive the report for future retrieval. At operation 450, the processor determines if all of the smart devices are done. In an embodiment, the processor determines if all smart devices that are scheduled have been compared to the MGRs. If all of the smart devices are not done, the processor moves to operation 430 with another smart device. If all of the smart devices are done, then the processor, at operation 455, controls the scheduler manager to wait for the next schedule.

At operation 460, the processor determines if there is a next schedule available. If no other schedules are available at that time, then the processor controls the scheduling manager to wait for the next schedule at operation 455. If there is a next schedule available, then the process moves to operation 430 for the device triggered by the schedule.

As discussed herein, one or more steps can be performed by a processor or different components controlled by the processor. However, the processor can directly perform the steps performed by components controlled by the processor.

Although FIG. 4 illustrates one example of a process 400 scheduling of a comparison of a MGR with device parameters in an industrial process control and automation system, various changes may be made to FIG. 4. For example, while FIG. 4 shows a series of steps, various steps could overlap, occur in parallel, occur in a different order, or occur any number of times. In addition, the process 400 could include any number of events, event information retrievals, and notifications.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed:

1. A method comprising:
receiving a master golden record for a device of a plurality of devices in an industrial automation system, wherein the master golden record includes one or more parameter values for the device for a mode of the industrial automation system;
identifying an active mode for the industrial process control and automation industrial automation system;
responsive to a triggering of a comparison, comparing current parameter values of the device with the one or more parameter values of the master golden record for the active mode; and
generating a report comprising differences between the one or more parameters values of the master golden record and the current parameter values of the device.

2. The method of claim 1, wherein the one or more parameter values of the master golden record is set at a time of commissioning.

3. The method of claim 1, further comprising:
receiving a schedule including when to trigger a comparison of each device of the plurality of devices.

4. The method of claim 3, further comprising:
auditing all user actions of modifying the master golden record, the active mode, or the schedule.

5. The method of claim 1, wherein the report further comprises a number of device comparisons that failed or passed, a number of smart devices that a comparison could not be performed, a number of devices that are cancelled, a number of devices that encountered an issue during execution; and exact configuration parameters that changed from the one or more parameter values of the master golden record.

6. The method of claim 1, further comprising:
archiving the report and providing access for future retrieval of the report.

7. The method of claim 1, wherein different master golden records are provided for different modes of the industrial automation system.

8. An apparatus comprising:
a memory configured to store a master golden record; and
a processing device coupled to the memory and configured to:
receive the master golden record for a device of a plurality of devices in an industrial automation system, wherein the master golden record includes one or more parameter values for the device for a mode of the industrial automation system;
identify an active mode for the industrial automation system;
responsive to a triggering of a comparison, compare current parameter values of the device with the one or more parameter values of the master golden record for the active mode; and
generate a report comprising differences between the one or more parameters values of the master golden record and the current parameter values of the device.

9. The apparatus of claim 8, wherein the one or more parameter values of the master golden record is set at a time of commissioning.

10. The apparatus of claim 8, wherein the processing device is further configured to:
receive a schedule including when to trigger a comparison of each device of the plurality of devices.

11. The apparatus of claim 10, wherein the processing device is further configured to:
audit all user actions of modifying the master golden record, the active mode, or the schedule.

12. The apparatus of claim 8, wherein the report further comprises a number of device comparisons that failed or passed, a number of smart devices that a comparison could not be performed, a number of devices that are cancelled, a number of devices that encountered an issue during execution; and exact configuration parameters that changed from the one or more parameter values of the master golden record.

13. The apparatus of claim 8, wherein the processing device is further configured to:
archive the report and providing access for future retrieval of the report.

14. The apparatus of claim 8, wherein different master golden records are provided for different modes of the industrial automation system.

15. A non-transitory computer readable medium embodying a computer program, the computer program comprising computer readable program code for:
receiving a master golden record for a device of a plurality of devices in an industrial automation system, wherein the master golden record includes one or more parameter values for the device for a mode of the industrial automation system;
identifying an active mode for the industrial automation system;
responsive to a triggering of a comparison, comparing current parameter values of the device with the one or more parameter values of the master golden record for the active mode; and
generating a report comprising differences between the one or more parameters values of the master golden record and the current parameter values of the device.

16. The non-transitory computer readable medium of claim 15, wherein the one or more parameter values of the master golden record is set at a time of commissioning.

17. The non-transitory computer readable medium of claim 15, wherein the computer readable program code further comprises computer readable program code for:
receiving a schedule including when to trigger a comparison of each device of the plurality of devices.

18. The non-transitory computer readable medium of claim 17, wherein the computer readable program code further comprises computer readable program code for:
auditing all user actions of modifying the master golden record, the active mode, or the schedule.

19. The non-transitory computer readable medium of claim 15, wherein the report further comprises a number of device comparisons that failed or passed, a number of smart devices that a comparison could not be performed, a number of devices that are cancelled, a number of devices that encountered an issue during execution; and exact configuration parameters that changed from the one or more parameter values of the master golden record.

20. The non-transitory computer readable medium of claim 15, wherein the computer readable program code further comprises computer readable program code for:
archiving the report and providing access for future retrieval of the report.
